(19) United States
(12) Patent Application Publication
(10) Pub. No.: US 2012/0169002 A1
(43) Pub. Date: Jul. 5, 2012

(54) MODULAR STRUCTURE FOR SUPPORTING BLANKS

(75) Inventor: Almerino Canuto, Casale Sul Sile (IT)

(73) Assignee: FCS SYSTEM SRL, CASALE SUL SILE (IT)

(21) Appl. No.: 13/394,604

(22) PCT Filed: Sep. 11, 2009
(86) PCT No.: PCT/IT09/00409

§ 371 Date: Mar. 7, 2012

(51) Int. Cl. B23Q 3/00

(52) U.S. Cl. 269/296

(57) ABSTRACT

A modular structure, particularly for supporting blanks, which includes at least one flat plate provided with a plurality of seats for interconnection between the plate and a blank or the like by at least one anchoring element, which includes a first part, which can be associated detachably with the plate, and a second part, which is provided with first fixing elements for the detachable connection of the anchoring element to a recess of the blank, where the first fixing elements include, in particular, fingers which can be inserted in the recess and protrude from the anchoring element along substantially one direction and can move transversely with respect to the direction for their engagement with the lateral surfaces of the recess.

### TECHNICAL FIELD

The present invention relates to a modular structure, particularly for supporting blanks.

### BRIEF DESCRIPTION OF RELATED ART

Currently, in the context of chip-forming machining and in the production of single parts assigned to order there is the need to organize a particularly versatile production system, i.e., one which can adapt to the production of several mutually different products. In particular, the execution of certain operations, such as for example painting, cleaning and assembly, or the execution of various machining processes, such as for example chip-forming processes, require locking the part and/or blank in a position that is preset for the treatment thereof.

This type of production system, commonly known as job-shop, is practically the stereotype of the production method that is the opposite of mass production.

In production to order, the need is felt to use a flexible production system but at the same time the lack of absolute automation makes manual interventions important. In particular, it is convenient to note that the placement and corresponding fixing of the part to be machined on the machine tool are performed manually.

Known devices, which are used for the positioning and locking of the blank, are constituted usually by two vertically elongated spacers, whose height and relative distance can be changed as a function of the dimensions and shape of the part to be locked.

EP 1346794 discloses in particular a modular fixing system which comprises a flat plate that has a plurality of threaded holes and cylindrical spacers which, by way of jaws that can move radially inside each spacer, retain respective threaded tension members, which can be inserted respectively in the complementarily threaded holes of the plate and in complementarily threaded holes provided in the blank to be worked.

Although this known structure allows advantageously the centering and stable locking of the blanks, it is susceptible of improvements. This structure in fact requires the provision of complementarily threaded cavities inside the blank.

Further, the use of a threaded coupling might cause wear problems on the threaded portion of the tension member, which in the long term may cause a reduction in the stability of the coupling.

Moreover, the threaded coupling between the body and the blank slows the operations for mounting and removing such blank.

### BRIEF SUMMARY

The aim of the present invention is to solve the above noted problems, eliminating the drawbacks of the cited background art, by devising a modular structure, particularly for supporting blanks, which allows to position and lock rapidly and stably the parts on the platform of any machine, so as to achieve the desired machinings.

Within this aim, the invention provides a supporting structure that allows to perform rapidly the preliminary operations for locking the part, in order to reduce production costs, but at the same time reduces or eliminates wear caused by the relative lockings between the parts involved in the locking of the part.

The invention further provides a supporting structure that is capable of ensuring optimum precision in the centering of the blank, moreover allowing repeatability of such centering in case of reworking performed at a later time.

The invention further provides a supporting structure that allows very safe and easy use even by a workforce that is not particularly qualified.

The invention further provides a use which is substantially flexible and can be adapted easily and rapidly also to the machining of parts that have significantly different weights, dimensions and shapes.

The invention further provides a supporting structure which combines with the preceding characteristics that of having low production costs and can be obtained with ordinary and known machines and systems.

A modular structure is provided, particularly for supporting blanks, according to the invention, which comprises at least one flat plate provided with a plurality of seats for interconnection between said plate and a blank or the like by means of at least one anchoring element, which comprises a first part, which can be associated detachably with said plate, and a second part, which is provided with first fixing means for the detachable connection of said at least one anchoring element to a recess of said blank, said first fixing means comprising fingers which can be inserted in said recess and protrude from said at least one anchoring element along substantially one direction and can move transversely with respect to said direction for their engagement with the lateral surfaces of said recess.

### BRIEF DESCRIPTION OF THE DRAWINGS

Further characteristics and advantages of the present invention will become better apparent from the description of preferred but not exclusive embodiments of a modular structure according to the invention, illustrated by way of non-limiting example in the accompanying drawings, wherein:

FIG. 1 is a perspective view of a modular structure according to the invention;

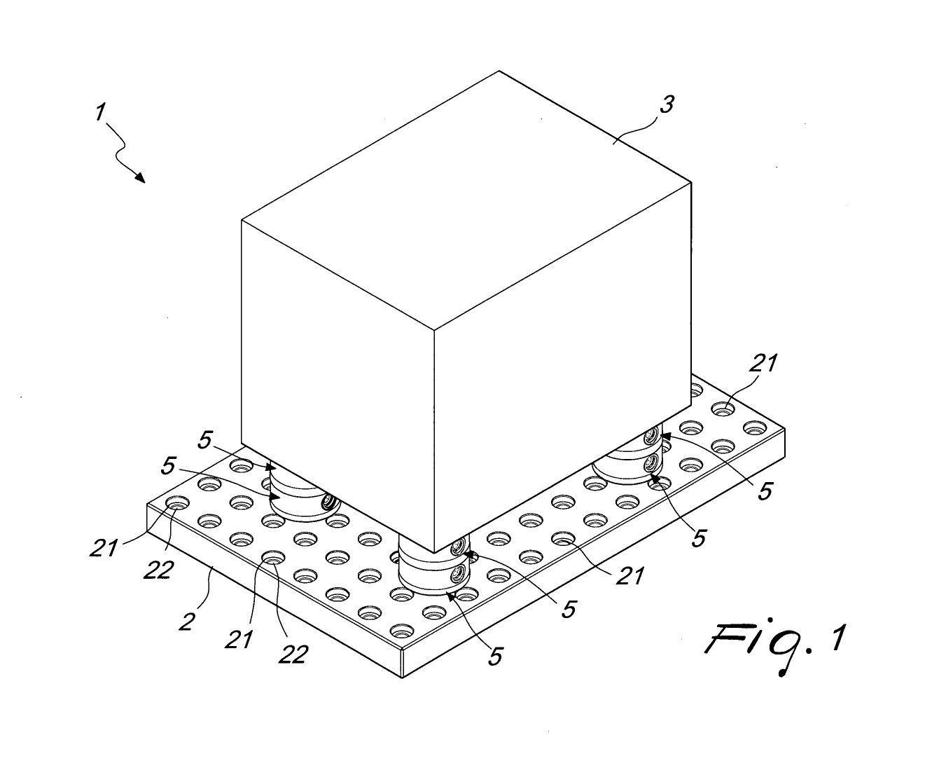

FIG. 2 is an exploded perspective view of the modular structure according to the invention, in which the blank has been omitted for reasons of clarity in illustration;

FIG. 3 is a perspective view of the anchoring element;

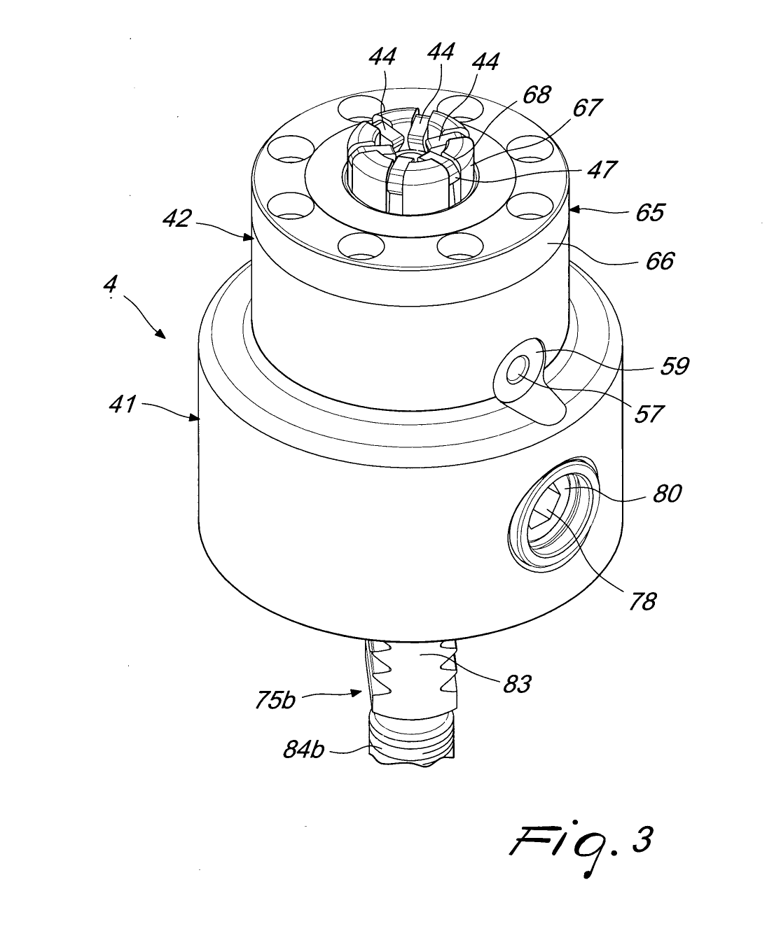

FIG. 4 is a top view of the anchoring element;

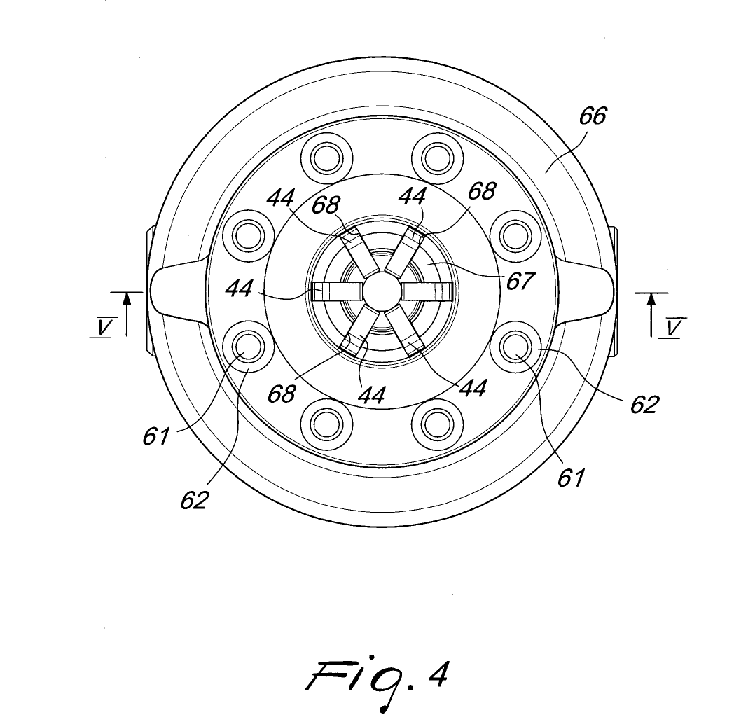

FIG. 5 is a front sectional view of the anchoring element before the fingers engage the recess of the blank;

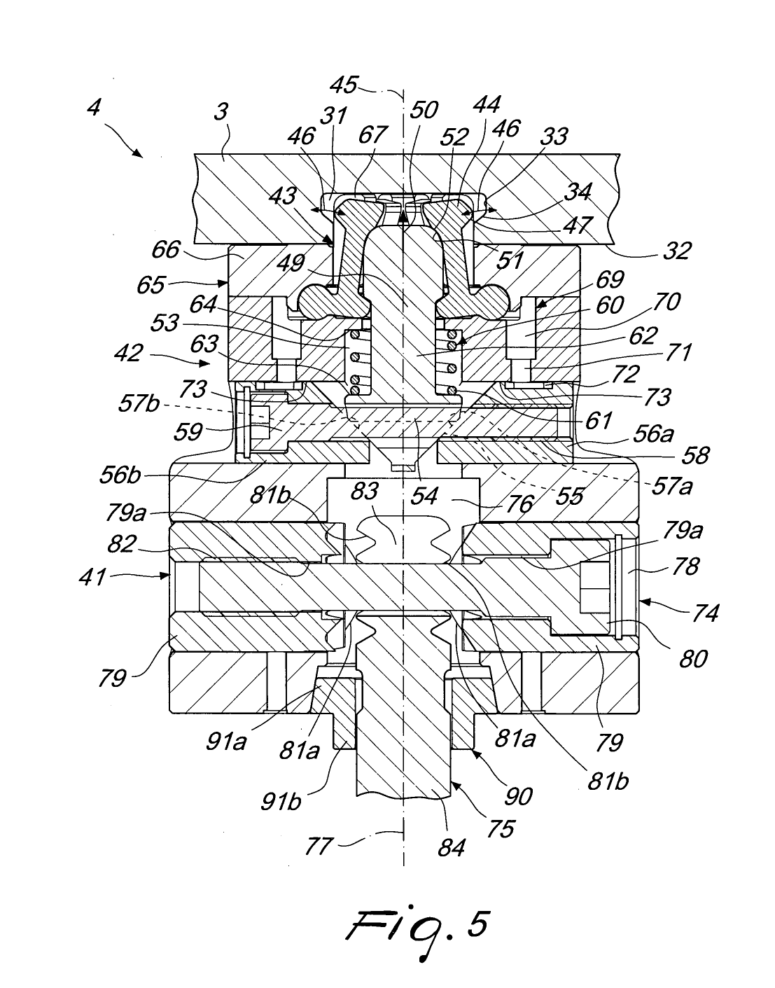

FIG. 6 is a front sectional view of the anchoring element with the fingers engaged with the recess;

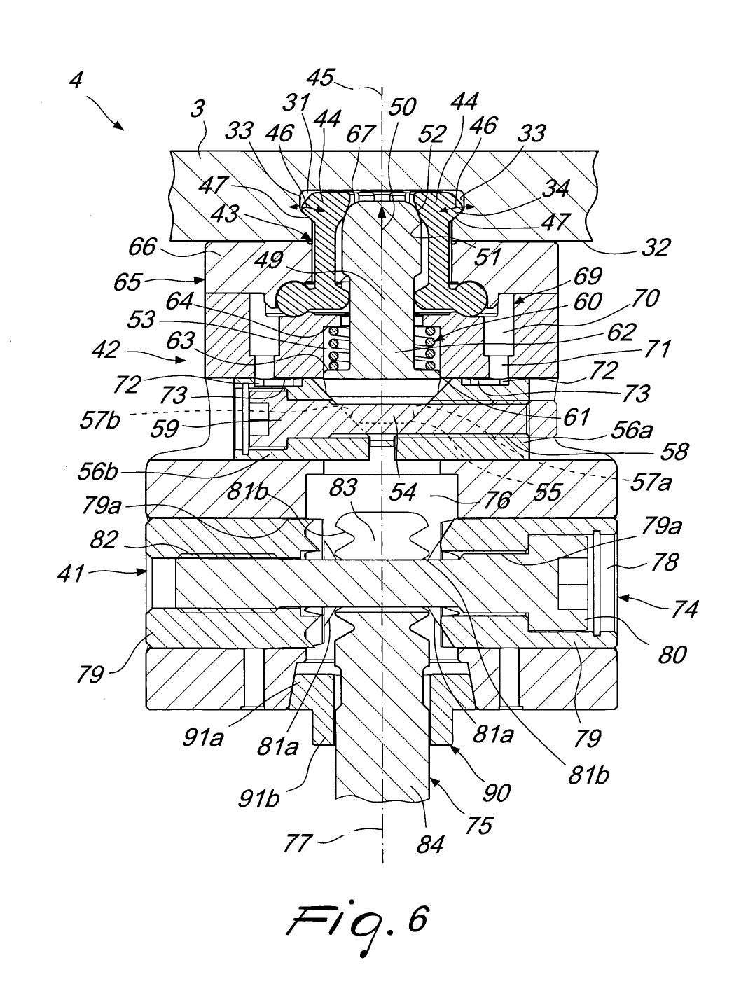

FIG. 7 is a perspective view of the spacer that can be used with the invention;

FIG. 8 is a front exploded view of the spacer of FIG. 7.

### DETAILED DESCRIPTION

With reference to the figures, the modular structure 1 is particularly suitable to support at least one blank 3, or in general any part to be machined and/or assembled, and comprises at least one substantially flat plate 2, which is locked on a worktable (not shown in the figures).

The plate 2 has, at its upper face, a plurality of seats 21, which are arranged advantageously according to a grid-like structure.

Interconnection between the plate 2 and the blank 3 occurs by means of at least one anchoring element, generally designated by the reference numeral 4, which optionally can be mated with a spacer 5.

The anchoring element 4 comprises a first part 41 and a second part 42 which is superimposed on the first one, both having a substantially cylindrical shape.

The second part 42 is provided with first fixing means 43 for the detachable connection of the anchoring element 4 to at least one recess 31 of the blank 3. Each recess 31 is formed on the surface 32 of the blank 3 without threads and so as to face the anchoring element 4.

The first fixing means 43 comprise fingers 44, which protrude from the anchoring element 4 for insertion in the recess 31. In particular, the fingers 44 protrude upward from the second part 42 of the anchoring element 4 substantially along an axial direction 45 and can move in a direction 46 that is transverse with respect to the direction 45 and is substantially radial with respect to it. The transverse movement of the fingers 44 allows them to engage the internal lateral surface 33 of the recess 31, thus preventing the translational motion of the blank in any direction.

In particular, the fingers 44 are arranged radially around the direction 45, so that their movement in a transverse direction 46 makes them move away from or toward the direction 45.

Advantageously, the fingers 44 are provided in an upper region with respective teeth 47, which are adapted to engage within an annular hollow 34 formed on the internal lateral surface 33 of the recess 31. The engagement of the fingers 44 with the internal lateral surface 33 of the recess 31 allows the fixing of the anchoring element 4 to the blank 3.

In order to move the fingers, the second part 42 can comprise a pin 49, which can perform a translational motion along the direction 45 and around which the fingers 44 are arranged. The stroke associated with the outward translational motion 50 of the pin 49 is such as to produce the abutment of an upper portion 51 of the pin 49 against an internal portion 52 of the fingers 44. The internal portion 52 is preferably concave in a lower region and convex in an upper region, so as to form a contour that is substantially complementary to the profile of the upper portion 51.

The outward translational motion 50 of the pin 49, by acting on the fingers 44 arranged in a circular pattern around the pin 49, causes the movement of such fingers in the direction 46. The movement in the direction 46 is substantially transverse to the direction 45 along which the outward translational motion 50 of the pin, by means of which the fingers 44 move mutually away, occurs.

Advantageously, the pin 49 is accommodated within a first through hole 53, which is formed in the second part 42 of the anchoring element 4. Further, since the pin 49 can perform a translational motion within the first through hole 53 along the direction 45, the axis of the first through hole 53 coincides with the direction 45.

Moreover, the pin 49 can have, at its lower portion 54, a substantially conical base 55. At the same time, the second part 42 of the anchoring element 4 can be provided with a pair of first jaws 56a and 56b, which advantageously can be guided within a radial hole 57 that passes radially through the second part 42 of the anchoring element 4, at a region below the pin 49, in particular through the conical base 55.

The first jaws 56a-56b can be moved mutually closer transversely to the direction 45, preferably at right angles thereto. In particular, the pair of jaws 56a-56b has respective inclined surfaces 57a and 57b, which are inclined symmetrically with respect to the direction 45. Each one of these inclined surfaces 57a and 57b engages on opposite sides the substantially conical base 55 of the pin 49. The mutual approach of the pair of first jaws thus causes the outward translational motion 50 of the pin 49 by means of a mutual sliding of the surface of the base 55 with the inclined surfaces 57a, 57b of the jaws 56a-56b.

Advantageously, both jaws 56a-56b are provided with holes internally, so that they can be crossed by a first screw 59 arranged transversely to the direction 45. Further, at least one jaw 56a has a thread 58, so that the first screw 59, by passing through the jaw 56b which is not threaded, reaches the threaded jaw 56a and engages the thread 58 to produce the mutual approach of the jaws 56a-56b.

Conveniently, the second part 42 of the anchoring element 4 comprises elastic means 60, which act on the pin 49 in contrast with the outward translational motion 50. In greater detail, the elastic means 60 can comprise a helical spring 61, which is fitted around the stem 62 of the pin 49 and is interposed between a first abutment surface 63 formed at the substantially conical base 55 and a second abutment surface 64 that is formed in the first through hole 53, in the form of a radial tapering portion of the hole 53.

The second part 42 of the anchoring element 4 can comprise, in its upper region, a cover 65, which is advantageously divided into a base portion 66 and a portion 67 that protrudes from the latter. The base portion 66 in particular is provided with slots 68 which form respective guiding seats for the transverse movement of the fingers 44.

Conveniently, the anchoring element 4 is provided with a system 69 for preventing the rotation of the first jaws 56 about their own axis. In particular, the system 69 can comprise passages 70 that run substantially parallel to the direction 45 and are adapted to be crossed by dowels 71, which by protruding from the passages 70 enter appropriately provided longitudinal recesses 72 of the jaws 56a and 56b. The recesses 72 are provided on the side 73 of the jaws 56a and 56b that is in contact with the passages 70.

The first part 41 of the anchoring element 4 can be associated with the plate 2 and can comprise second fixing means 74, which allow the detachable connection of the anchoring element 4 on the plate 2, directly or by means of a spacer 5 which can be associated with the plate 2.

The second fixing means 74 of the anchoring element 4 comprise a second pair of jaws 79, between which a first tension member 75 is clamped which has an end 84 which can be locked detachably in an opening 22 formed in a respective seat of the plate 2 or in the spacer 5.

The clamping of the first tension member 75 within the first part 41 of the anchoring element 4 can occur with known methods.

Advantageously, the first part 41 of the anchoring element 4 has a second axial hole 76, which runs along a direction 77, and a third hole 78, which is substantially transverse and connected to the second axial hole 76. The third hole 78, which is preferably perpendicular to the direction 77 of the second hole 76, is designed to accommodate the pair of second jaws 79 provided with through openings 79a along the longitudinal axis of the third hole 78.

The through openings 79a are crossed by a second screw 80, which is coaxial to the third hole 78 and is adapted to adjust the clamping motion of the second jaws 79 toward the first tension member 75.

The second jaws 79 are provided with toothed surfaces 81a, which face each other and are symmetrical with respect to the direction 77. At least one of the second jaws 79 is provided with a threaded portion 82 that is necessary for screwing the second screw 80 within the second jaws 79, in order to achieve their mutual approach. The second jaws 79, by moving mutually closer, lock between them the first tension member 75 by the engagement of the toothed surfaces 81a of the second jaws 79 with the toothed surfaces 81b of the first tension member 75.

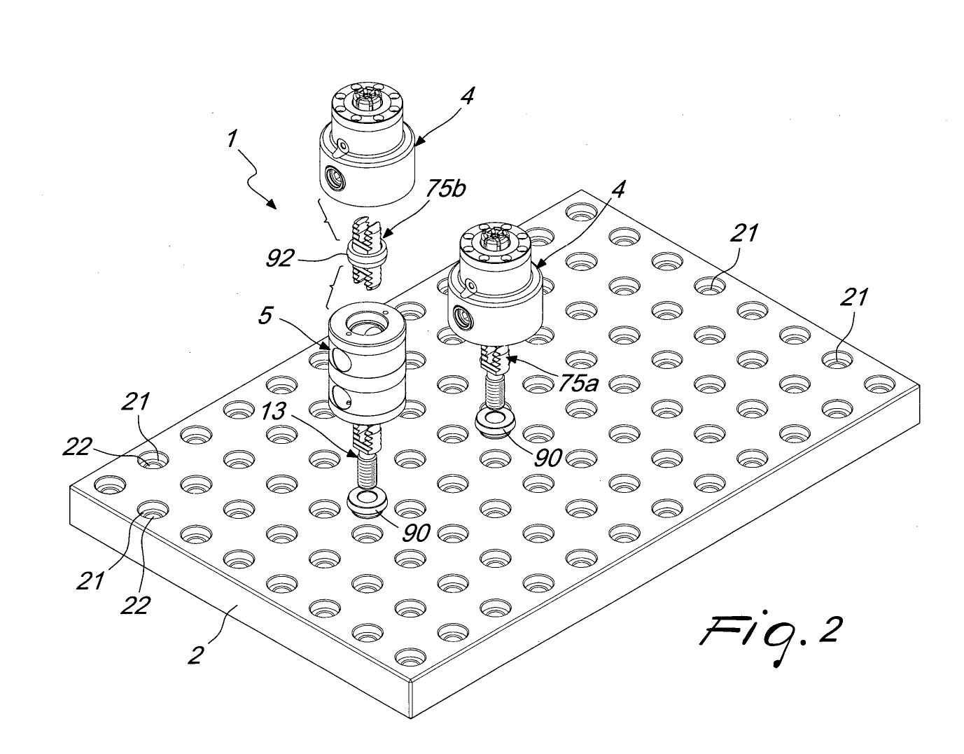

Advantageously, the first segment 83 of the first tension member 75 can be U-shaped, as shown in FIG. 2, so that it can be crossed internally by the second screw 80.

As mentioned earlier, the end 84 of the first tension member 75 can be locked detachably in an opening 22 formed in a seat 21 of the plate 2 or inside the spacer 5. In the first case, the first tension member 75 is designated here by the reference numeral 75a and the second end 84a of this first tension member 75a is threaded for engagement within the complementarily threaded portion 23 of the opening 22 formed in the plate 2. In the second case, instead, the first tension member 75 is designated here by the reference numeral 75b and has toothed surfaces, as will become better apparent hereinafter.

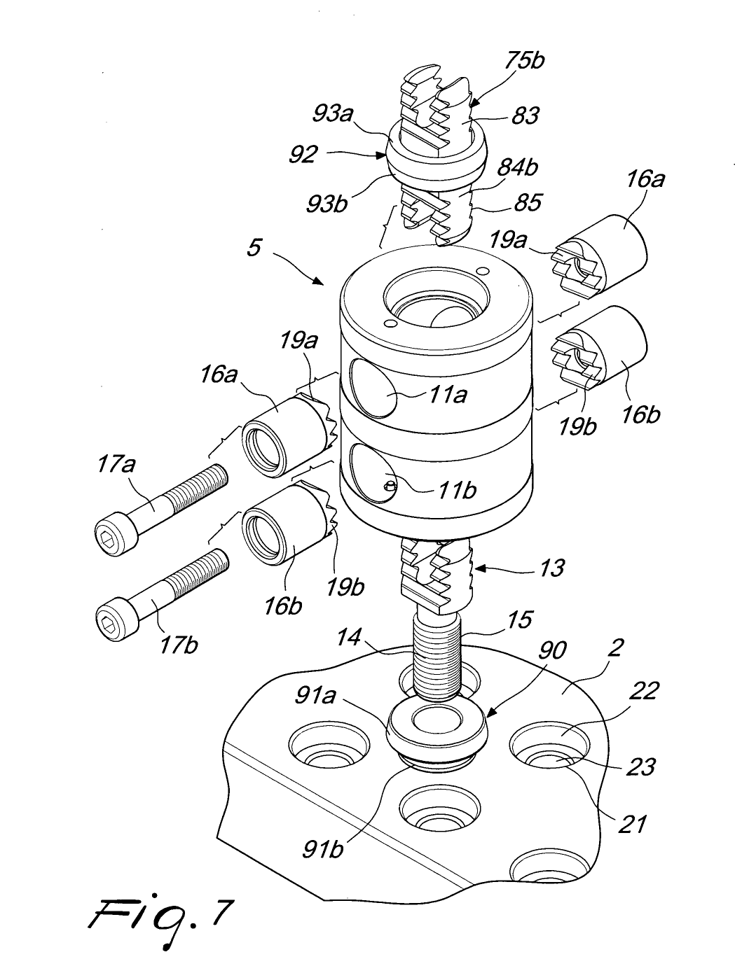

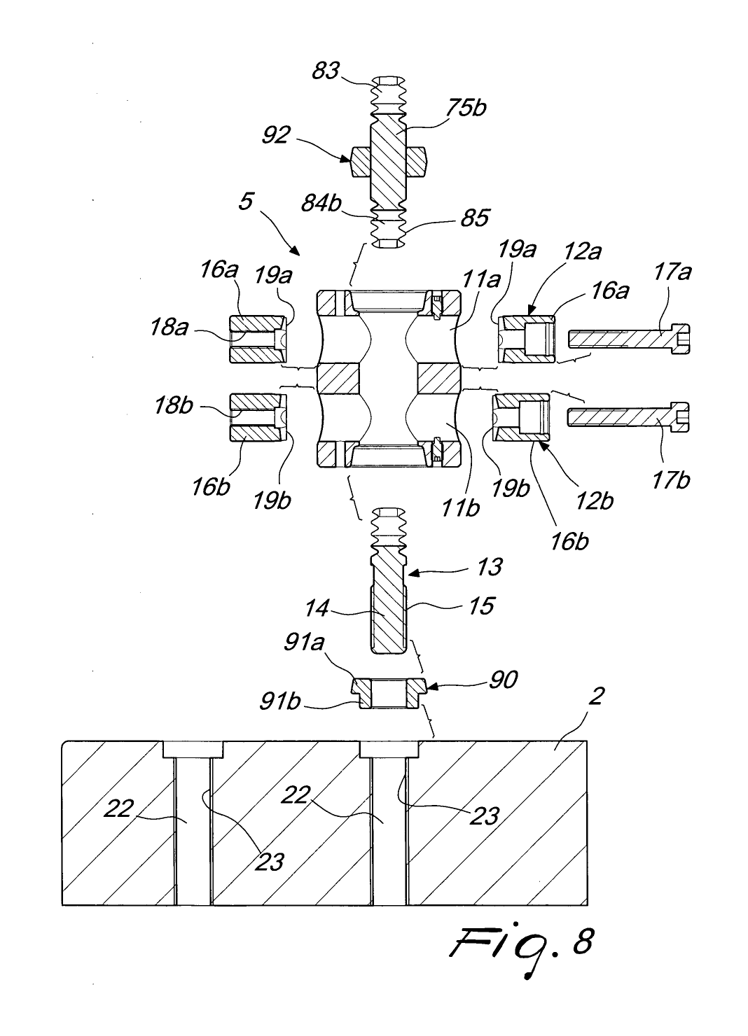

FIGS. 7 and 8 illustrate the spacer 5 that can be used optionally to fix the anchoring element to the plate 2. The spacer 5 can be substantially cylindrical and can comprise a first radial hole 11a inside which third fixing means 12a are inserted for detachable locking of the second end 84b of the first tension member 75b. Further, the spacer 5 can comprise a second radial hole 11b inside which fourth fixing means 12b are inserted for the detachable locking of a second tension member 13 provided with an end 14 with threads 15 which can be locked detachably in the complementarily threaded portion 23 of the opening 22 formed in the plate 2.

Advantageously, the fixing means 12a and 12b of the spacer 5 comprise structures that are substantially identical to those of the second fixing means 74 of the anchoring element 4 and operate in the same manner In particular, the fixing means 12a and 12b comprise respectively a third pair of jaws 16a and a fourth pair of jaws 16b, and a third screw 17a and a fourth screw 17b, which pass through the respective pairs of jaws 16a and 16b. Both pairs of jaws 17a and 17b are provided internally with holes, and at least one of the two jaws of each pair is provided with a second thread 18a and 18b for the screwing of the screws 17a and 17b. Further, both jaws 17a and 17b have threaded portions 19a and 19b for locking respectively the first tension member 75b and the second tension member 13.

If the anchoring element 4 is connected to the spacer 5, the end 84b of the first tension member 75b is mirror-symmetrical with respect to the first segment 83, i.e., it too is U-shaped and provided with lateral surfaces with a set of teeth 85.

Advantageously, the first tension members 75a-75b and the second tension members 15 can be coupled to centering means constituted by a bush 90. In greater detail, the bush 90 can comprise two portions 91a and 91b, which can be accommodated in a respective seat of the two elements to be coupled and provided internally with holes for the passage of the tension members. Advantageously, the upper portion 91a is frustum-shaped, while the lower portion is cylindrical.

However, depending on the elements to be coupled, it is also possible to use a symmetric bush 92, in which the two portions 93a and 93b have a mutually symmetrical shape with respect to the side that they have in common.

Based on what has been shown, the use of the invention is as follows. The user who wishes to fix a blank 3 screws into the most appropriate seat 21 of the plate 2 the end of the first tension member 75a or the end of the second tension member 13, as required, depending on whether it is necessary or not to resort to the spacer 5 to lock the blank 3 at a higher level. It should be noted that advantageously the first tension member 75a and the second tension member 13 are structurally identical, as shown in FIG. 2.

If the spacer 5 is used, it locks by way of the fourth fixing means 12b the second tension member 13, previously locked to the plate 2. Then the first tension member 75b is inserted on the spacer 5, locking it by way of the third fixing means 12a.

At this point, therefore, the anchoring element 4 is applied by inserting the first segment 83 of the first tension member 75a or 75b within the second axial hole 76 of the anchoring element 4. The locking of the first tension member 75a or 75b to the anchoring element 4 is achieved by screwing the second screw 80 of the anchoring element 4.

Subsequently, the blank 3 is rested on the anchoring element 4 so that the fingers 44 that protrude enter the recess 31 formed in the blank 3.

Then the first fixing means 43 are activated in order to lock the anchoring element 4 with the blank 3.

In particular, by means of the screwing of the first screw 59 of the anchoring element 4, the mutual approach of the first jaws 56a and 56b is produced. The approach of the inclined surfaces 57a and 57b of the first jaws 56a and 56b produces the sliding in the direction 45 of the conical base 55 of the pin 49, thus producing the outward translational motion 50 of the pin 49 toward the recess 31. This outward translational motion 50 of the pin in turn produces the movement in the transverse direction 46 of the fingers 44, which by moving mutually apart engage the internal lateral surface 33 of the recess 31 and grip it, thus allowing the fixing of the anchoring element 4 to the blank 3.

Of course, depending on the work to be performed and on the particular shape of the blank, such blank can be provided advantageously with a plurality of recesses 31 to allow the stable resting of a plurality of anchoring elements 4 interconnected in a lower region directly to the plate 2 or to spacers 5 which can be associated with the plate 2.

It has thus been found that the invention provides a modular structure for supporting blanks having been devised which allows to position them and lock them rapidly and stably to perform a preset machining and/or operation, also ensuring the achievement of optimum centering thereof even by scarcely expert operators.

It has also been found that this locking allows to perform rapidly the preliminary operations for locking the part without having to provide threaded holes in the blanks, allowing to reduce both production costs and the wear caused by relative lockings between the components.

Moreover, the structure according to the invention allows to avoid, or at least reduce drastically, inconvenient successive variations of the positioning and corresponding locking of the blank, such as for example in the case of several reworking processes performed on the same blank, thus avoiding the onset of sources of errors and of great time losses.

The invention is of course susceptible of numerous modifications and variations.

Thus, for example, the shapes of the elements can be different from the cylindrical one and therefore for example can be prism-like or frustum-shaped or truncated pyramid-like, so long as they have at least two resting surfaces for such blank and such plate.

Likewise, the second fixing means and the third fixing means can be provided differently; in particular, they can be similar to the first fixing means, i.e., of the type with fingers.

The modular structure according to the invention thus conceived is susceptible of numerous modifications and variations.

The materials used, as well as the dimensions that constitute the individual components of the invention, may of course be any according to requirements and to the state of the art.

1-14. (canceled)

15. A modular structure, particularly for supporting blanks, comprising at least one flat plate provided with a plurality of seats for interconnection between said plate and a blank or the like by means of at least one anchoring element, which comprises a first part, which can be associated detachably with said plate, and a second part, which is provided with first fixing means for the detachable connection of said at least one anchoring element to a recess of said blank, said first fixing means comprising fingers which can be inserted in said recess and protrude from said at least one anchoring element along substantially one direction and can move transversely with respect to said direction for their engagement with the lateral surfaces of said recess.

16. The modular structure according to claim 15, wherein said second part comprises a pin that can perform a translational motion along said direction and with such a stroke as to produce the abutment of an upper portion of said pin with said fingers by means of an outward translational motion of said pivot, in order to move said fingers transversely mutually apart.

17. The modular structure according to claim 16, wherein said second part comprises a first through hole within which said pin can perform a translational motion along said direction, the axis of said hole coinciding with said direction.

18. The modular structure according to claim 16, wherein said pin comprises, at a lower portion thereof, a substantially conical base, said second part of said anchoring element comprising a pair of first jaws that can be moved mutually closer transversely with respect to said direction, said first jaws having surfaces which are inclined symmetrically with respect to said direction and engage on opposite sides said substantially conical base, so that the mutual approach of said first jaws produces said outward translational motion of said pin.

19. The modular structure according to claim 18, wherein said pair of first jaws has a thread in at least one of said first jaws, said first jaws being crossed by a screw that is arranged transversely to said direction and is adapted to engage said thread to produce the mutual approach of said first jaws.

20. The modular structure according to claim 16, wherein said second part comprises elastic means that act on said pin in contrast with said outward translational motion.

21. The modular structure according to claim 20, wherein said elastic means comprise a helical spring that is fitted on said pin and is interposed between a first abutment surface formed at said conical base of the pin and a second abutment surface that is formed in said first through hole.

22. The modular structure according to claim 15, wherein said first fixing means comprise a cover that can be associated with said second part and is provided with slots that form respective guiding seats for the transverse movement of said fingers.

23. The modular structure according to claim 18, wherein said anchoring element comprises a system for preventing the rotation of said first jaws about their own axis.

24. The modular structure according to claim 15, wherein said first part of the anchoring element comprises second fixing means for the detachable connection of said at least one anchoring element to said plate or to a spacer which can be associated with said plate.

25. The modular structure according to claim 24, wherein said second fixing means of the anchoring element comprise a pair of second jaws, between which a first tension member is clamped which has an end which can be locked detachably in an opening formed in a respective seat of the plate or in said spacer.

26. The modular structure according to claim 25, wherein said second jaws and said first tension member comprise mutually facing toothed surfaces, which can engage each other to lock said first tension member between said second jaws, said second jaws comprising through openings through which a second screw is inserted for adjusting a clamping motion of said second jaws toward said first tension member.

27. The modular structure according to claim 25, wherein the spacer is substantially cylindrical and comprises a first radial hole provided with third fixing means for the detachable locking of said end of the first tension member and a second radial hole provided with fourth fixing means for the detachable locking of a second tension member provided with an end that can be locked detachably in said opening formed on the respective seat of the plate.

28. The modular structure according to claim 27, wherein said second, third and fourth fixing means comprise centering means constituted by a bush.
